(19) United States
(12) Patent Application Publication
(10) Pub. No.: US 2026/0338953 A1
(43) Pub. Date: Oct. 29, 2026

(54) OPTICAL RANGING DEVICE

(71) Applicant: Asia Optical Co., Inc., Taichung (TW)

(72) Inventors: Chung-Wei Wang, Taichung (TW); Yu-Hui Hsu, Taichung (TW); Shih-Kung Chen, Taichung (TW); Hua-Tang Liu, Taichung (TW)

(21) Appl. No.: 19/654,542

(22) Filed: Apr. 22, 2026

(30) Foreign Application Priority Data
Apr. 29, 2025 (TW) 114116141

(51) Int. Cl. G01S 17/86; G01J 5/00; G01S 17/08

(52) U.S. Cl. CPC G01S 17/86; G01J 5/00; G01S 17/08; G01J 2005/0077

(57) ABSTRACT

An optical ranging device is provided. In operation, visible light from an external environment passes through a first optical lens group and an eyepiece group to form an image. Ranging light emitted from a ranging light source passes through a first optical lens group and reaches an measured object, and the measured object reflects the ranging light to form reflected light. The reflected light passes through a second optical lens group and is received by a ranging light receiver. A second receiver receives invisible light from the external environment to form a second image signal. A display generates a second image beam according to the second image signal, wherein the second image beam passes through the eyepiece group and is combined with the image. Optical axes of the first optical lens group and the second optical lens group are disposed in parallel without coinciding.

### BACKGROUND OF THE INVENTION

### Field of the Invention

The invention relates to a technical field of thermal imaging devices and ranging devices, and more particularly to an optical ranging device.

### Description of the Related Art

Laser rangefinders and thermal imagers are currently widely used commercial products. However, laser rangefinders and thermal imagers are separate products and are rarely integrated into one product. Therefore, users must purchase two products. Moreover, if distance measurement and object temperature detection are required in the same situation, users must switch between laser rangefinders and thermal imagers, which is quite inconvenient.

### BRIEF SUMMARY OF THE INVENTION

An object of the invention is to provide an optical ranging device which combines the functions of existing laser rangefinders and thermal imagers.

The optical ranging device in accordance with an exemplary embodiment of the invention includes a visible light module, a ranging light emitting module, a ranging light receiving module, a second receiving module, and a displaying module. The visible light module includes an eyepiece group and a first optical lens group combined with each other, wherein visible light from an external environment passes through the first optical lens group and the eyepiece group to form an image. The ranging light emitting module includes a ranging light source and the first optical lens group, wherein the ranging light source emits ranging light, the ranging light passes through the first optical lens group and reaches an measured object, and the measured object reflects the ranging light to form reflected light. The ranging light receiving module includes a ranging light receiver and a second optical lens group, wherein the reflected light passes through the second optical lens group and is received by the ranging light receiver. The second receiving module includes a second receiver which receives invisible light from the external environment to form a second image signal. The displaying module includes a display which generates a second image beam according to the second image signal, wherein the second image beam passes through the eyepiece group and is combined with the image. Optical axes of the first optical lens group and the second optical lens group are disposed in parallel without coinciding.

In another exemplary embodiment, the second receiving module is an infrared light receiving module. The second receiving module further includes a light splitter. The ranging light passes through the light splitter and is incident on the first optical lens group. The invisible light is infrared light. The infrared light passes through the second optical lens group and is guided by the light splitter to the second receiver. The second receiver is an infrared light receiver. The visible light module further includes a prism group. The eyepiece group, the prism group and the first optical lens group are combined with each other. The visible light from the external environment passes through the first optical lens group, the prism group and the eyepiece group to form the image.

In yet another exemplary embodiment, the optical ranging device further includes a control and calculation module including a processor and a storage unit electrically connected to the processor. The light splitter is either a light-splitting prism or a light-splitting plane mirror. The light-splitting prism or the light-splitting plane mirror has an optical interface which allows the ranging light and the reflected light to pass through and reflects infrared light. The second receiving module is an infrared light receiving module and further includes an infrared light lens group, and the infrared light passes through the infrared light lens group and is received by the infrared light receiver. The processor is electrically connected to the ranging light source, the ranging light receiver, the infrared light receiver, and the display, the processor loads and executes a distance calculation program and an infrared light image generation program from the storage unit, the distance calculation program calculates a distance to the measured object, and the infrared light image generation program generates a second image beam from the infrared light image signal.

In another exemplary embodiment, the eyepiece group and the second optical lens group are combined with each other, and the visible light from the external environment passes through the second optical lens group and the eyepiece group to form the image.

In yet another exemplary embodiment, the optical ranging device further includes a visible light module. The visible light module includes a third optical lens group. The visible light from the external environment passes through the third optical lens group and the eyepiece group to form the image.

In another exemplary embodiment, the second receiving module is an infrared light receiving module. The second receiving module further includes a light splitter. The reflected light and the invisible light pass through the second optical lens group and are split by the light splitter. The reflected light is received by the ranging light receiver, the invisible light is infrared light, and the infrared light is received by the infrared light receiving module to form an infrared light image signal. The visible light module further includes a prism group. The eyepiece group, the prism group and the first optical lens group are combined with each other. The visible light from the external environment passes through the first optical lens group, the prism group and the eyepiece group to form the image.

In yet another exemplary embodiment, the optical ranging device further includes a control and calculation module which includes a processor and a storage unit electrically connected to the processor. The light splitter is either a light-splitting prism or a light-splitting plane mirror. The light-splitting prism or the light-splitting plane mirror has an optical interface which allows the ranging light and the reflected light to pass through and reflects infrared light. The second receiving module is an infrared light receiving module and further includes an infrared light lens group, and the infrared light passes through the infrared light lens group and is received by the infrared light receiver. The processor is electrically connected to the ranging light source, the ranging light receiver, the infrared light receiver, and the display, the processor loads and executes a distance calculation program and an infrared light image generation program from the storage unit, the distance calculation program calculates a distance to the measured object, and the infrared light image generation program generates a second image beam from the infrared light image signal.

In another exemplary embodiment, the eyepiece group and the second optical lens group are combined with each other, and the visible light from the external environment passes through the second optical lens group and the eyepiece group to form the image.

In yet another exemplary embodiment, the optical ranging device further includes a visible light module. The visible light module includes a third optical lens group. The visible light from the external environment passes through the third optical lens group and the eyepiece group to form the image.

In another exemplary embodiment, the second image beam is a thermal image beam. The thermal image beam is configured to form a thermal image. The thermal image is superposed on the image to simultaneously show temperature information of objects in the external environment.

In yet another exemplary embodiment, the optical ranging device includes a ranging light emitting module, a ranging light receiving module, and a second receiving module. The ranging light emitting module includes a ranging light source and a first optical lens group, wherein the ranging light source emits ranging light, the ranging light passes through the first optical lens group and reaches an measured object, and the measured object reflects the ranging light to form reflected light. The ranging light receiving module includes a ranging light receiver and a second optical lens group, wherein the reflected light passes through the second optical lens group and is received by the ranging light receiver. The second receiving module includes a second receiver and a light splitter, wherein invisible light and the reflected light pass through the second optical lens group and is split by the light splitter, the reflected light is received by the ranging light receiver, and the invisible light is received by the second receiver to form a second image signal. The optical axes of the first optical lens group and the second optical lens group are disposed in parallel without coinciding.

In another exemplary embodiment, the optical ranging device further includes a control and calculation module including a processor and a storage unit electrically connected to the processor. The light splitter is either a light-splitting prism or a light-splitting plane mirror. The light-splitting prism or the light-splitting plane mirror has an optical interface which allows the ranging light and the reflected light to pass through and reflects infrared light. The second receiving module is an infrared light receiving module and further includes an infrared light lens group, and the infrared light passes through the infrared light lens group and is received by the infrared light receiver. The processor is electrically connected to the ranging light source, the ranging light receiver, the infrared light receiver, and the display, the processor loads and executes a distance calculation program and an infrared light image generation program from the storage unit, the distance calculation program calculates a distance to the measured object, and the infrared light image generation program generates a second image beam from the infrared light image signal.

In yet another exemplary embodiment, the optical ranging device further includes a visible light module and a displaying module. The visible light module includes an eyepiece group and a prism group. The displaying module includes a display. The eyepiece group, the prism group and the first optical lens group are combined with each other. Visible light from an external environment passes through the first optical lens group, the prism group and the eyepiece group to form an image. The display generates a second image beam according to the second image signal. The second image beam passes through the eyepiece group and is combined with the image.

In another exemplary embodiment, the second image beam is a thermal image beam. The thermal image beam is configured to form a thermal image. The thermal image is superposed on the image to simultaneously show temperature information of objects in the external environment.

In yet another exemplary embodiment, the optical ranging device further includes a visible light module which includes an eyepiece group. The eyepiece group and the second optical lens group are combined with each other, and the visible light from the external environment passes through the second optical lens group and the eyepiece group to form the image.

In another exemplary embodiment, the optical ranging device further includes a visible light module which includes a third optical lens group and an eyepiece group. The visible light from the external environment passes through the third optical lens group and the eyepiece group to form the image.

In the invention, the ranging light emitting module, the ranging light receiving module, and the infrared light receiving module are integrated into a single optical ranging device, wherein the infrared light receiving module can be configured separately or combined with the ranging light receiving module. Furthermore, a light splitter is used to separate the ranging light and the infrared light into different optical paths for individual reception. Therefore, the optical ranging device of the invention is capable of ranging and thermal imaging functions, allowing the user to simultaneously obtain information on the distance and temperature of the measured object.

### BRIEF DESCRIPTION OF THE DRAWINGS

FIG. 1 is a schematic view of an optical ranging device in accordance with a first embodiment of the invention.

FIG. 2 is a schematic view of an optical ranging device in accordance with a second embodiment of the invention.

FIG. 3 is a side view of the optical ranging device of FIG. 2.

FIG. 4 is a schematic view of an optical ranging device in accordance with a third embodiment of the invention.

FIG. 5 is a side view of the optical ranging device of FIG. 4.

FIG. 6 is a schematic view of an optical ranging device in accordance with a fourth embodiment of the invention.

### DETAILED DESCRIPTION OF THE INVENTION

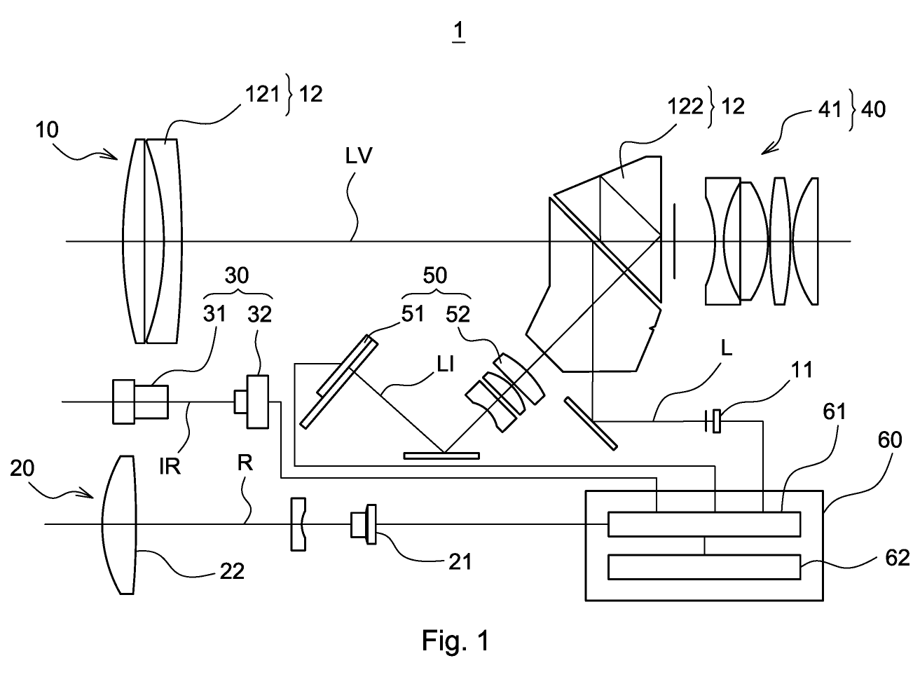

FIG. 1 is a schematic view of an optical ranging device in accordance with a first embodiment of the invention, wherein the optical ranging device 1 includes a ranging light emitting module 10, a ranging light receiving module 20, a second receiving module 30, a visible light module 40, a displaying module 50 and a control and calculation module 60.

The ranging light emitting module 10 includes a ranging light source 11 and a first optical lens group 12. The ranging light source 11 is configured to emit ranging light L. In this embodiment, the ranging light source 11 is a laser light source, such as a laser diode. The first optical lens group 12 includes a first lens group 121 and a first prism group 122. The ranging light L is incident on the first prism group 122. After being refracted and reflected by the first prism group 122, the ranging light L is projected along the optical axis of the first lens group 121 onto a measured object in the external environment. The measured object reflects the ranging light L to form reflected light R.

The ranging light receiving module 20 includes a ranging light receiver 21 and a second optical lens group 22. The reflected light R passes through the second optical lens group 22 and is received by the ranging light receiver 21. It is worth noting that optical axes of the first optical lens group 12 and the second optical lens group 22 are disposed in parallel without coinciding.

The second receiving module 30 is configured to receive invisible light from the external environment to form a second image signal. Specifically, in this embodiment, the second receiving module 30 is an infrared light receiving module including an infrared light lens group 31 and an infrared light receiver 32 (i.e. the second receiver). Infrared light IR from the external environment passes through the infrared light lens group 31 and is received by the infrared light receiver 32 to form a thermal imaging signal (i.e. the second image signal).

The visible light module 40 includes an eyepiece group 41. The eyepiece group 41 and the first optical lens group 12 are combined to form an optical path. Visible light LV from the external environment passes through the first optical lens group 12 to form an observation image. The user is able to view the observation image through the eyepiece group 41 whereby the optical ranging device 1 is capable of achieving a telescopic effect.

The displaying module 50 includes a display 51 and a display optical lens group 52. The display 51 generates image light LI which includes an information image beam (first image beam) and a thermal image beam (second image beam) described later. The information image beam has, for example, distance information of the measured object, time information, temperature information, and aiming pattern. The image light LI is incident on the first prism group 122 of the first optical lens group 12 via the display optical lens group 52, and is refracted and reflected by the first prism group 122, such that the user can view the information image of the image light LI through the eyepiece group 41.

The display optical lens group 52 forms the information image and the observation image at the same position, allowing the user to view both simultaneously. Further, the thermal image of the image beam LI can be superimposed on the observation image, enabling the user to simultaneously view the temperature information of various objects in the external environment.

The control and calculation module 60 includes a processor 61 and a storage unit 62 electrically connected to the processor 61. The processor 61 is electrically connected to the ranging light source 11, the ranging light receiver 21, the infrared light receiver 32, and the display 51. The processor 61 loads and executes a distance calculation program, a thermal image generation program, a calibration program, and a power management program from the storage unit 62. The distance calculation program is used to calculate the distance to the measured object, the thermal image generation program is used to generate a thermal image beam from the thermal image signal, the calibration program is used to correct the grayscale value of the thermal image beam according to the reference physical quantity of the external environment, and the power management program is used to control the power supplied to the ranging light source 11, the ranging light receiver 21, the infrared light receiver 32, and the display 51, and simultaneously to control the generation of the ranging light L of the ranging light source 11.

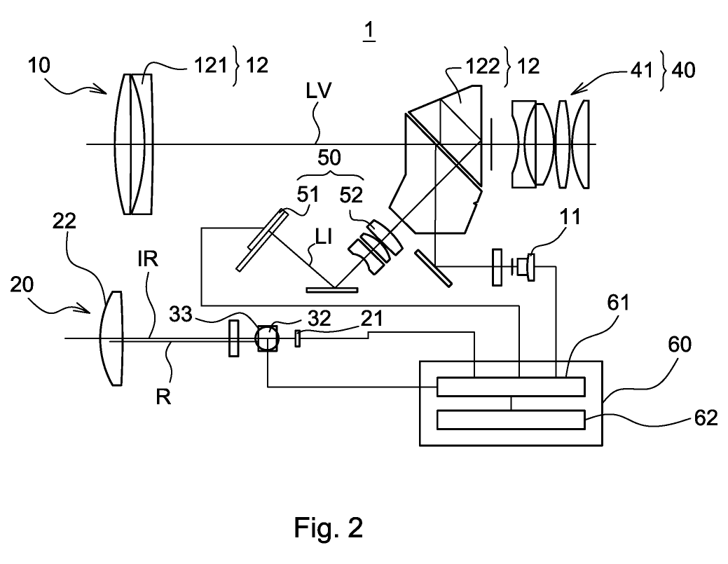

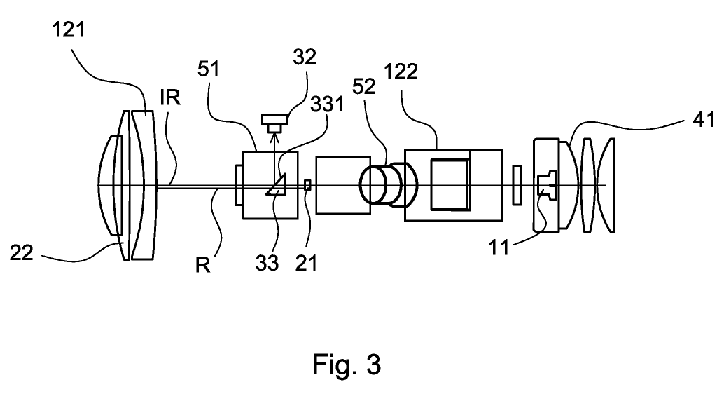

FIGS. 2 and 3 depict an optical ranging device in accordance with a second embodiment of the invention, wherein the parts same as those of the first embodiment are labeled with the same reference numerals and the descriptions thereof are omitted. The second embodiment differs from the first embodiment in that the infrared light receiving module 30 of the optical ranging device 1 includes a light splitter 33. In the second embodiment, the infrared light receiving module 30 and the ranging light receiving module 20 are combined with each other. The light splitter 33 is disposed between the ranging light receiver 21 and the second optical lens group 22. The reflected light R and the infrared light IR pass through the second optical lens group 22 and are split by the light splitter 33. The reflected light R is received by the ranging light receiver 21. The infrared light IR is received by the infrared light receiver 32 to form a thermal image signal. In the second embodiment, the light splitter 33 is a light-splitting prism or a light-splitting plane mirror. The light splitter 33 has an optical coating on one surface to form an optical interface 331. The optical interface 331 reflects the infrared light IR with a wavelength of 2μm to 12μm, but allows the ranging light L or reflected light R with a wavelength of 850μm to 950μm to pass through.

In the second embodiment, the ranging light L emitted by the ranging light source 11 is projected onto the measured object through the first optical lens group 12. The eyepiece group 41 of the visible light module 40 is combined with the first optical lens group 12. The user views the observation image formed by the visible light LV of the external environment through the first optical lens group 12 through the eyepiece group 41. The image light LI generated by the display 51 of the displaying module 50 is refracted and reflected by the first prism group 122. The user views the information image formed by the image light LI through the eyepiece group 41. The control and calculation module 60 is electrically connected to the ranging light source 11, the ranging light receiver 21, the infrared light receiver 32, and the display 51.

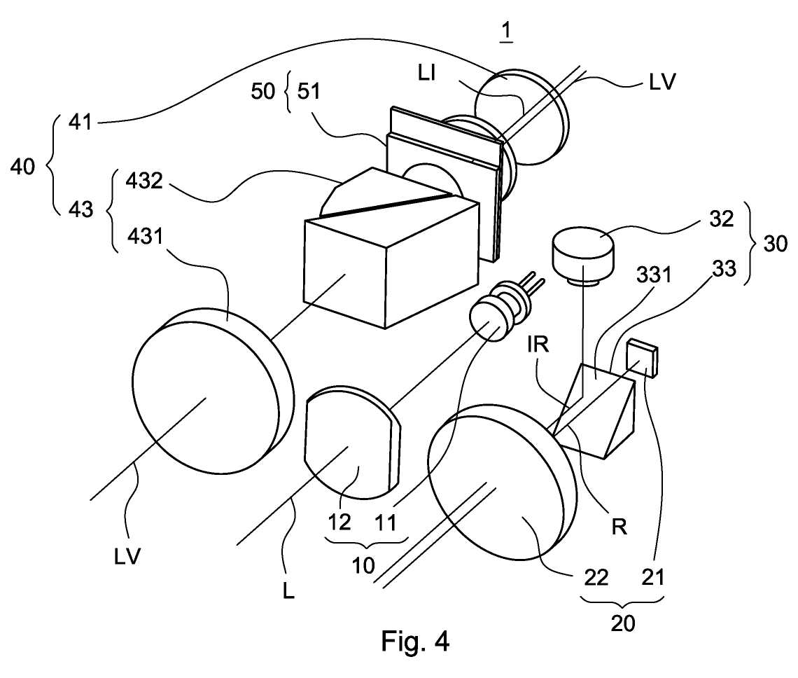

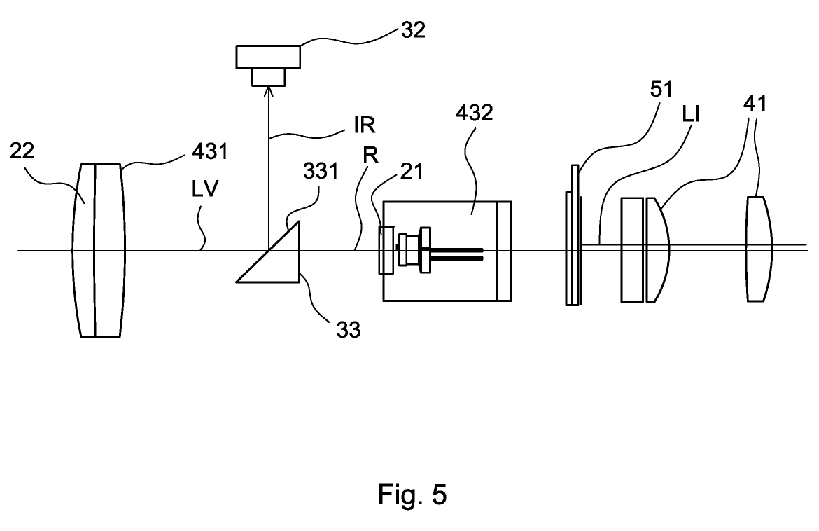

FIGS. 4 and 5 depict an optical ranging device in accordance with a third embodiment of the invention, wherein the parts same as those of the second embodiment are labeled with the same reference numerals and the descriptions thereof are omitted. The third embodiment differs from the second embodiment in that the telescope group 40 in the third embodiment is independent from the ranging light emitting module 10, the ranging light receiving module 20 and the infrared light receiving module 30. The first optical lens group 12 of the ranging light emitting module 10 in the third embodiment has one or more lenses but no prism group.

The ranging light L emitted by the ranging light source 11 is projected onto the measured object through multiple lenses of the first optical lens group 12 and is reflected by the measured object to form the reflected light R. The reflected light R and the infrared light IR pass through the second optical lens group 22 and are split by the light splitter 33, as shown in FIG. 5. The ranging light receiver 21 receives the reflected light R and the infrared light receiver 32 receives the infrared light IR to form a thermal image signal.

The visible light module 40 of the third embodiment includes an eyepiece group 41 and a third optical lens group 43. Visible light LV from the external environment passes through the third optical lens group 43 to form an observation image, and the user views the observation image through the eyepiece group 41. The third optical lens group 43 includes a third lens group 431 and a third prism group 432.

In the third embodiment, the displaying module 50 has a display 51 disposed between the eyepiece group 41 and the third optical lens group 43. The display 51 may have a transparent display panel, and the position of the display 51 is the same as the position of the observation image formed by passing the visible light LV through the third optical lens group 43. Thus, the user can directly view the thermal image beam and information image beam generated by the display 51 through the eyepiece group 41. In the third embodiment, the displaying module 50 does not have a display optical lens group.

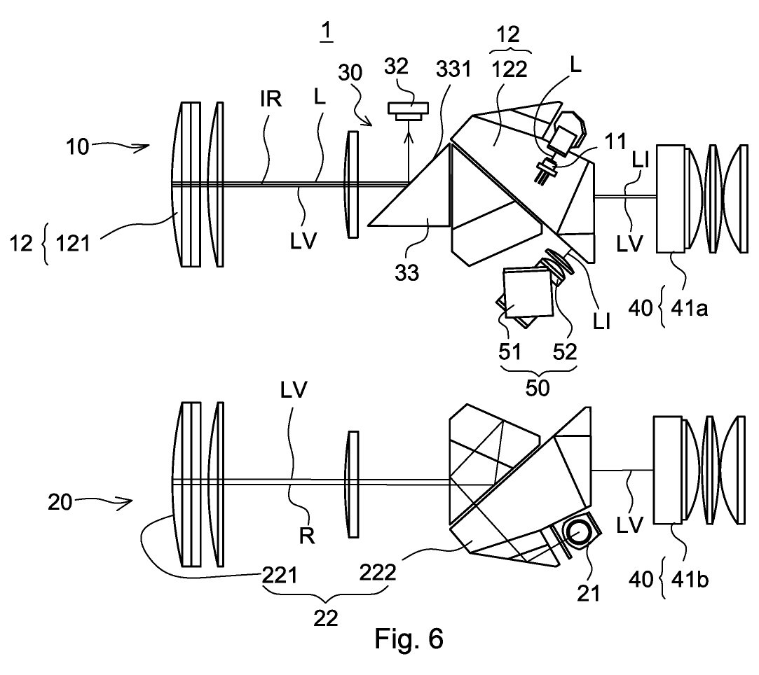

FIG. 6 depicts an optical ranging device in accordance with a fourth embodiment of the invention, wherein the parts same as those of the second embodiment are labeled with the same reference numerals and the descriptions thereof are omitted. The fourth embodiment differs from the second embodiment in that in the fourth embodiment an eyepiece group 41a of the visible light module 40 is combined with the first optical lens group 12 of the ranging light emitting module 10, and another eyepiece group 41b of the visible light module 40 is combined with the second optical lens group 22 of the ranging light receiving module 20. After the visible light LV from the external environment passes through the first optical lens group 12 and the second optical lens group 22 to form an observation image, the user views the observation image through the eyepiece groups 41a and 41b.

In the fourth embodiment, the light splitter 33 is combined with the first optical lens group 12. Infrared light IR is guided by the first optical lens group 12 to the infrared light receiver 32 for reception. The ranging light L emitted by the ranging light source 11 passes through the light splitter 33 and is projected onto the measured object through the first optical lens group 12 to become the reflected light R. In the fourth embodiment, the second optical lens group 22 includes a second lens group 221 and a second prism group 222. The reflected light R is guided by the second optical lens group 22 to the ranging light receiver 21 for reception.

The image light L1 generated by the display 51 is incident on the first prism group 122 of the first optical lens group 12 via the display optical lens group 52, and the message image formed by the image light L1 is located at the same position as the observation image, so that the user can view the observation image and the message image at the same time.

The fifth embodiment of the optical ranging device of the invention (not shown) is substantially the same as the fourth embodiment described above. In the fourth embodiment, the ranging light emitting module 10 and the infrared light receiving module 30 have a shared element (first lens group 121), so that the optical paths for the ranging light emitting module 10 and the infrared light receiving module 30 have an overlapped part. In the fifth embodiment, however, the ranging light receiving module 20 and the infrared light receiving module 30 have a shared element (second lens group 221), so that the optical paths for the ranging light receiving module 20 and the infrared light receiving module 30 have an overlapped part.

The sixth embodiment (not shown) of the optical ranging device of the invention is substantially the same as the fourth and fifth embodiments described above. The difference is that the sixth embodiment has two infrared light receiving modules. One infrared light receiving module is located at the side where the ranging light emitting module is located (same as the fourth embodiment), while the other infrared light receiving module is located at the side where the ranging light receiving module is located (same as the fifth embodiment).

The seventh embodiment of the optical ranging device of the invention (not shown) is substantially the same as the fourth or fifth embodiment described above, except for the infrared light receiving module. Specifically, the seventh embodiment has only one infrared light receiving module, which is the same as the fourth and fifth embodiments. The difference is that the infrared light receiving module in the seventh embodiment is disposed separately, which is the same as the first embodiment.

In the invention, the ranging light emitting module, the ranging light receiving module, and the infrared light receiving module are integrated into a single optical ranging device, wherein the infrared light receiving module can be configured separately or combined with the ranging light receiving module. Furthermore, a light splitter is used to separate the ranging light and the infrared light into different optical paths for individual reception. Therefore, the optical ranging device of the invention is capable of ranging and thermal imaging functions, allowing the user to simultaneously obtain information on the distance and temperature of the measured object.

What is described above is only the preferred embodiment of the invention, and the scope of the invention is not limited thereto. That is, the simple equivalent changes and modifications made according to the description of the invention and the claims are all within the scope of the invention. Further, any one of the embodiments or claims is not required to achieve all the objects or advantages or features of the invention. Further, the abstract and title are only used to assist in the search of patent documents and are not intended to limit the scope of the invention.

What is claimed is:

1. An optical ranging device, comprising:
a visible light module comprising an eyepiece group and a first optical lens group combined with each other, wherein visible light from an external environment passes through the first optical lens group and the eyepiece group to form an image;
a ranging light emitting module comprising a ranging light source and the first optical lens group, wherein the ranging light source emits ranging light, the ranging light passes through the first optical lens group and reaches an measured object, and the measured object reflects the ranging light to form reflected light;
a ranging light receiving module comprising a ranging light receiver and a second optical lens group, wherein the reflected light passes through the second optical lens group and is received by the ranging light receiver;
a second receiving module comprising a second receiver which receives invisible light from the external environment to form a second image signal;
a displaying module comprising a display which generates a second image beam according to the second image signal, wherein the second image beam passes through the eyepiece group and is combined with the image;
wherein optical axes of the first optical lens group and the second optical lens group are disposed in parallel without coinciding.

2. The optical ranging device as claimed in claim 1, wherein:
the second receiving module is an infrared light receiving module;
the second receiving module further comprises a light splitter;
the ranging light passes through the light splitter and is incident on the first optical lens group;
the invisible light is infrared light;
the infrared light passes through the second optical lens group and is guided by the light splitter to the second receiver;
the second receiver is an infrared light receiver;
the visible light module further comprises a prism group;
the eyepiece group, the prism group and the first optical lens group are combined with each other;
the visible light from the external environment passes through the first optical lens group, the prism group and the eyepiece group to form the image.

3. The optical ranging device as claimed in claim 2, further comprising:
a control and calculation module comprising a processor and a storage unit electrically connected to the processor;
wherein the light splitter is either a light-splitting prism or a light-splitting plane mirror;
wherein the light-splitting prism or the light-splitting plane mirror has an optical interface which allows the ranging light and the reflected light to pass through and reflects infrared light;
wherein the second receiving module is an infrared light receiving module and further comprises an infrared light lens group, and the infrared light passes through the infrared light lens group and is received by the infrared light receiver;
wherein the processor is electrically connected to the ranging light source, the ranging light receiver, the infrared light receiver, and the display, the processor loads and executes a distance calculation program and an infrared light image generation program from the storage unit, the distance calculation program calculates a distance to the measured object, and the infrared light image generation program generates a second image beam from the infrared light image signal.

4. The optical ranging device as claimed in claim 2, wherein the eyepiece group and the second optical lens group are combined with each other, and the visible light from the external environment passes through the second optical lens group and the eyepiece group to form the image.

5. The optical ranging device as claimed in claim 2, further comprising:
a visible light module;
wherein the visible light module comprises a third optical lens group;
wherein the visible light from the external environment passes through the third optical lens group and the eyepiece group to form the image.

6. The optical ranging device as claimed in claim 1, wherein:
the second receiving module is an infrared light receiving module;
the second receiving module further comprises a light splitter;
the reflected light and the invisible light pass through the second optical lens group and are split by the light splitter;
the reflected light is received by the ranging light receiver, the invisible light is infrared light, and the infrared light is received by the infrared light receiving module to form an infrared light image signal;
the visible light module further comprises a prism group;
the eyepiece group, the prism group and the first optical lens group are combined with each other;
the visible light from the external environment passes through the first optical lens group, the prism group and the eyepiece group to form the image.

7. The optical ranging device as claimed in claim 6, further comprising:
a control and calculation module comprising a processor and a storage unit electrically connected to the processor;
wherein the light splitter is either a light-splitting prism or a light-splitting plane mirror;
wherein the light-splitting prism or the light-splitting plane mirror has an optical interface which allows the ranging light and the reflected light to pass through and reflects infrared light;
wherein the second receiving module is an infrared light receiving module and further comprises an infrared light lens group, and the infrared light passes through the infrared light lens group and is received by the infrared light receiver;
wherein the processor is electrically connected to the ranging light source, the ranging light receiver, the infrared light receiver, and the display, the processor loads and executes a distance calculation program and an infrared light image generation program from the storage unit, the distance calculation program calculates a distance to the measured object, and the infrared light image generation program generates a second image beam from the infrared light image signal.

8. The optical ranging device as claimed in claim 6, wherein the eyepiece group and the second optical lens group are combined with each other, and the visible light from the external environment passes through the second optical lens group and the eyepiece group to form the image.

9. The optical ranging device as claimed in claim 6, further comprising:
a visible light module;
wherein the visible light module comprises a third optical lens group;
wherein the visible light from the external environment passes through the third optical lens group and the eyepiece group to form the image.

10. The optical ranging device as claimed in claim 1, wherein:
the second image beam is a thermal image beam;
the thermal image beam is configured to form a thermal image;
the thermal image is superposed on the image to simultaneously show temperature information of objects in the external environment.

11. An optical ranging device, comprising:
a ranging light emitting module comprising a ranging light source and a first optical lens group, wherein the ranging light source emits ranging light, the ranging light passes through the first optical lens group and reaches an measured object, and the measured object reflects the ranging light to form reflected light;
a ranging light receiving module comprising a ranging light receiver and a second optical lens group, wherein the reflected light passes through the second optical lens group and is received by the ranging light receiver;
a second receiving module comprising a second receiver and a light splitter, wherein invisible light and the reflected light pass through the second optical lens group and is split by the light splitter, the reflected light is received by the ranging light receiver, and the invisible light is received by the second receiver to form a second image signal;
wherein optical axes of the first optical lens group and the second optical lens group are disposed in parallel without coinciding.

12. The optical ranging device as claimed in claim 11, further comprising:
a control and calculation module comprising a processor and a storage unit electrically connected to the processor;
wherein the light splitter is either a light-splitting prism or a light-splitting plane mirror;
wherein the light-splitting prism or the light-splitting plane mirror has an optical interface which allows the ranging light and the reflected light to pass through and reflects infrared light;
wherein the second receiving module is an infrared light receiving module and further comprises an infrared light lens group, and the infrared light passes through the infrared light lens group and is received by the infrared light receiver;
wherein the processor is electrically connected to the ranging light source, the ranging light receiver, the infrared light receiver, and the display, the processor loads and executes a distance calculation program and an infrared light image generation program from the storage unit, the distance calculation program calculates a distance to the measured object, and the infrared light image generation program generates a second image beam from the infrared light image signal.

13. The optical ranging device as claimed in claim 11, further comprising:
a visible light module comprising an eyepiece group and a prism group;
a displaying module comprising a display;
wherein the eyepiece group, the prism group and the first optical lens group are combined with each other;
wherein visible light from an external environment passes through the first optical lens group, the prism group and the eyepiece group to form an image;
wherein the display generates a second image beam according to the second image signal;
wherein the second image beam passes through the eyepiece group and is combined with the image.

14. The optical ranging device as claimed in claim 13, wherein:
the second image beam is a thermal image beam;
the thermal image beam is configured to form a thermal image;
the thermal image is superposed on the image to simultaneously show temperature information of objects in the external environment.

15. The optical ranging device as claimed in claim 11, further comprising:
a visible light module comprising an eyepiece group;
wherein the eyepiece group and the second optical lens group are combined with each other, and the visible light from the external environment passes through the second optical lens group and the eyepiece group to form the image.

16. The optical ranging device as claimed in claim 11, further comprising:
a visible light module comprising a third optical lens group and an eyepiece group;
wherein the visible light from the external environment passes through the third optical lens group and the eyepiece group to form the image.
